(19) United States
(12) Patent Application Publication
(10) Pub. No.: US 2010/0166154 A1
(43) Pub. Date: Jul. 1, 2010

(54) SYSTEM AND METHOD FOR FLEXIBLE FORWARDING OF EMERGENCY CALL INFORMATION

(75) Inventor: Richard A. Peters, Grapevine, TX (US)

Correspondence Address: FULBRIGHT & JAWORSKI L.L.P, 2200 ROSS AVENUE, SUITE 2800, DALLAS, TX, 75201-2784, US

(73) Assignee: VIXXI Solutions, Inc., Greenwood Village, CO (US)

(21) Appl. No.: 12/421,501

(22) Filed: Apr. 9, 2009

Related U.S. Application Data
(63) Continuation-in-part of application No. 11/969,147, filed on Jan. 3, 2008.
(60) Provisional application No. 60/980,697, filed on Oct. 17, 2007.

(51) Int. Cl. H04M 11/04

(52) U.S. Cl. 379/45

(57) ABSTRACT

The present invention is directed generally to geographic referenced telephone switching. 9-1-1 emergency telephone calls are routed to alternative public safety answering points (PSAPs) based on the caller's location in relation to the proper emergency service provider and the availability of primary and backup PSAPs. Essentially the formatter gathers and verifies caller information, matches transmission formats with the a determined call destination, generates and transmits a data communication with caller information, and terminates the phone call at the proper endpoint. In certain embodiments, calls that would typically be routed to PSAP equipment are routed to non-standard PSAP devices such as a cellular telephone operable to receive text messages.

### CROSS-REFERENCE TO RELATED APPLICATIONS

The present application is a continuation-in-part of co-pending and commonly-assigned U.S. patent application Ser. No. 11/969,147 titled “GEOGRAPHIC REFERENCED TELEPHONE SWITCHING,” filed Jan. 3, 2008, which claims priority to U.S. Provisional Patent Application Ser. No. 60/980,697 titled “GEOGRAPHIC REFERENCED TELEPHONE SWITCHING,” filed Oct. 17, 2007, the disclosures of which are hereby incorporated by reference. The present application is related to concurrently-filed and commonly-assigned U.S. patent application Ser. No. ______ [Attorney Docket No. 73729/P003US/1,0900338] titled “SYSTEM AND METHOD FOR EMERGENCY TEXT MESSAGING,” the disclosure of which is hereby incorporated herein by reference.

### TECHNICAL FIELD

The following description relates generally to forwarding of calls that are directed to a special telephony number, particularly geographically-sensitive calls, such as emergency calls (e.g., “9-1-1” emergency calls). The description further relates to flexible forwarding of emergency call information, such as the caller-supplied portion (e.g., voice and/or input text message) of a call and the call's corresponding Automatic Location Information (“ALI”) and/or Automatic Number Identification (“ANI”), to any defined forwarding endpoint that is capable of receiving such information. The description further relates to systems and methods for communicating emergency call information (e.g., ALI and/or ANI) to a specified forwarding endpoint in a format supported by the endpoint, such as in a proper format for being output to a destination Public Safety Answering Point's ALI display or a proper format for being output to a destination cellular telephone's display.

### BACKGROUND

Various systems have been proposed for handling telephone calls that are directed to a special number, such as emergency calls directed to telephone number 9-1-1. The basic 9-1-1 emergency call system is well-established in the United States, and other countries have similar systems for handling emergency calls. Such 9-1-1 calls are typically geographically-sensitive calls because the geographic location of the caller is generally important in determining the most appropriate emergency responder. For instance, the most appropriate fire, police, medical, or other emergency responder for a given caller may be determined based, at least in part, on the geographic location of the given caller. Various telecommunication systems have been proposed for handling geographically-sensitive calls, such as 9-1-1 calls.

Historical development and various operational aspects of the traditional 9-1-1 system in the U.S. are described in U.S. Pat. No. 4,893,325 titled “Integrated Public Safety Answering Point System”; U.S. Pat. No. 5,311,569 titled “Line-Based Public Safety Answering Point”; U.S. Pat. No. 6,385,302 titled “System and Method for Handling Special Number Calls Using On-Demand Answering Stations”; U.S. Pat. No. 6,587,545 titled “System for Providing Expanded Emergency Service Communication in a Telecommunication Network”; U.S. Pat. No. 6,744,859 titled “System and Apparatus for Providing Telephone Communication Between a Caller and a Special Number Call Answering Facility”; and U.S. Pat. No. 6,819,929 titled “System and Method for Routing Special Number Calls in a Telecommunication Network”, the disclosures of which are hereby incorporated herein by reference.

A basic 9-1-1 system provides for programming a telephone company end office (also known as a “central office” or a “Class 5 office”) with special 9-1-1 software for routing all 9-1-1 calls to a single destination. The single destination is generally referred to as a Public Safety Answering Point (PSAP). In such an arrangement, all telephones served by the central office have their 9-1-1 calls completed to the PSAP. However, the areas served by respective telephone company central offices do not line Lip with the political jurisdictions that determine the boundaries for which a PSAP may be responsible. That is, a municipal fire department or police department may geographically include an area outside the area served by the central office, a condition known as underlap. Likewise, the municipal fire or police department may encompass an area of responsibility that is less expansive than the area served by the central office, a situation known as overlap. Further, the original basic 9-1-1 systems did not provide any automated identification of the caller; but instead relied upon the PSAP human operator to obtain such information verbally from the caller.

Automatic Number Identification (ANI) is a feature (sometimes referred to as Calling Party Number (CPN)) that allows the caller's telephone number to be delivered with the call. Such ANI information can accompany a call, such as a 9-1-1 call, and the ANI information may be displayed to an operator at the PSAP. The feature is useful for identifying the caller and, if the caller cannot communicate or if the call is dropped or disconnected for some reason, for callback. A signaling scheme known as Centralized Automatic Message Accounting (CAMA), originally used to identify the originator of a long distance call for billing purposes, was adapted to facilitate ANI delivery to the PSAP.

The availability of the caller's telephone number to the PSAP (the ANI feature) led quickly to providing the caller's name and address as well. This was straightforwardly accomplished using the subscriber information stored by telephone companies based upon telephone number since the 1980's. New equipment at the PSAP enabled queries of an Automatic Location Identification (ALI) database using the caller's number provided by the ANI feature to ascertain name and address information. The ALI databases are typically maintained by the respective telephone company serving the PSAP. This was an improvement, but a problem still remained where several telephone company central offices served a town or county.

At the PSAP, operators generally have a telephone for receiving voice communication from a caller and an associated display (commonly referred to as an ALI display), such as a monitor, CRT, workstation, etc. for displaying textual information associated with a received call, such as the call's respective ANI and ALI information. The textual output displayed on the PSAP operator display may be in any of various predefined formats. For instance, the output to the display may be formatted into various predefined fields that are arranged on the screen in a predefined relative arrangement. As an example of typical operation, upon a call being received by the PSAP, the ANI information accompanying the call may be used to look tip the caller's ALI information in the ALI database. When the voice portion of the call is connected to an operator at the PSAP, the associated ANI and/or ALI information may be displayed to the operator on the operator's display. The information associated with the call (e.g., ANI and/or ALI information) is used to paint (or “populate”) the operator's display screen. The associated information is fixed-field type data, having a fixed length, etc. And, if the wrong information is included in the wrong field, it shows up in the wrong place on the operator's display, or it does not show up at all. ALI databases and PSAP operator displays for displaying textual ANI and/or ALI information (e.g., ALI displays) are well-known in the art, and examples of such are discussed further in U.S. Pat. No. 6,104,784 titled “Arrangement for Communicating Between Public Safety Answering Points and an Automatic Location Identifier Database”; U.S. Pat. No. 6,363,138 titled “E-9-1-1/ALI Information Manager and Management System”; U.S. Pat. No. 6,526,125 titled “System and Method for Automatic Location Identification Discrepancy Notification”; and U.S. Pat. No. 7,177,400 titled “System and Method for Providing a Map Image Supplemental to Automatic Location Identification Information”, the disclosures of which are hereby incorporated herein by reference.

Currently, approximately 99% of the PSAPs in the United States are, from a telephony standpoint, analog based, which means that they receive information, both digital and voice information, using analog interfaces such as modems and analog trunking, such as CAMA trunks and/or Feature Group D or DSO-type trunking to the PSAP. In practice, there are currently no digital interfaces in PSAPs for receiving information, such as SMS messages, emails or any other form of digital (e.g., Internet Protocol (IP)) information. Each and every one of these PSAPs is connected to a database that contains location information (e.g., the ALI database). The format of this database generally determines how the PSAP operator's display screen is painted when location information is presented for an incoming call received by the PSAP. There are currently approximately 400 different information display formats in U.S. 9-1-1 system.

As the situation of multiple central offices serving a PSAP occurred more frequently, it was clear that it was inefficient to build communication trunks from several central offices to a PSAP. As a result, the 9-1-1 tandem was developed. With that equipment, trunks from central offices are concentrated at a tandem office (a 9-1-1 tandem) from which a single trunk group serves a given PSAP. Often a 9-1-1 tandem comprises an otherwise common Class 5 telephone system end office (EO), with added software to configure it for 9-1-1 operations. Such concentration of trunks reduces size and cost of PSAP equipment. The tandem is a telephone company switch that provides an intermediate concentration and switching point. Tandems are used for many purposes, including intra-LATA (Local Access and Transport Area) toll calls, access to other local exchange carriers (LECs), and access to long distance carriers and telephone operators.

A significant development in 9-1-1 services has been the introduction of Enhanced 9-1-1 (E9-1-1). Some of the features of E9-1-1 include Selective Routing, ANI, ALI, Selective Transfer and Fixed Transfer. Selective Transfer enables one-button transfer capability to police, fire and EMS (Emergency Medical Service) agencies appropriate for the caller's location listed on the ALI display. Fixed Transfer is analogous to speed dialing.

Selective Routing is a process by which 9-1-1 calls are delivered to a specific PSAP based upon the street address of the caller. Selective Routing Tandems do not directly use address information from the ALI database to execute decisions regarding which PSAP to connect. Emergency services (e.g., police, fire and EMS) are typically delivered on a municipality basis. Often there will be one police department (e.g., municipal, county or state), but there may be several fire departments and EMS agencies. A town may be divided into response areas served by each respective agency. The response areas are overlaid and may be defined as geographic zones served by one particular combination of police, fire and EMS agencies. Such zones are commonly referred to as Emergency Service Zones (ESZ). Each ESZ contains the street addresses served by each type of responder. The ESZs are each assigned an identification number (usually 3-5 digits), known as Emergency Service numbers (ESN).

The Assignment of ESZs and corresponding ESNs enables the compilation of selective routing tables. The street addresses are derived from a Master Street Address Guide (MSAG), a database of street names and house number ranges within associated communities defining Emergency Service Zones (ESZs) and their associated Emergency Service Numbers (ESNs). This MSAG aids in proper routing of 9-1-1 calls by the 9-1-1 tandem; this is Selective Routing as implemented in an E9-1-1 system. Thus, the telephone company must have an MSAG valid address to be assigned the appropriate ESN for selective routing purposes and that information must be added to the 9-1-1 ALI database. It is by using such information that the selective routing capability of the Selective Routing Tandem can properly route a 9-1-1 call to the correct PSAP. If the information is not available in the ALI database, the record may be placed into an error file for further manual handling.

In a traditional PSAP environment, emergency call information (e.g., voice, ALI, and ANI information) can only be received by a PSAP in a specific format using specific equipment. Usually, the equipment is manufactured by one of the three large equipment manufacturers, either Positron, CML or Planned Equipment Corporation, and is designed specifically to receive ANI and ALI from the CAMA trunks at the telephone company. Most PSAPs have an alternate routing capability for situations where the PSAP is abandoned or disabled; however, this routing only sends this information to a predetermined PSAP with like equipment and like formatting. Any other type of routing typically takes a period of 30 to 45 days because the selected routing and switching equipment maintained by the local telephone company requires reprogramming.

In some instances, it is desirable to have all or a portion of emergency calls that would be directed to a given PSAP forwarded, with their respective call information (e.g., ALI and/or ANI), to an alternate PSAP or telecommunications device. As one example, consider when Hurricane Ike approached the coast of Galveston, Tex. in September 2008. In that instance the Galveston PSAP was abandoned and it became desirable to re-route emergency calls to another destination. The alternate route for the Galveston PSAP was the Galveston Emergency Response Center, which was also located in Galveston, and since the entire island of Galveston was evacuated, including the Emergency Response Center, many emergency calls were unanswered. Traditional techniques for re-routing emergency calls are insufficient where both primary and backup PSAPs are disabled or evacuated.

### SUMMARY

In view of above, various shortcomings in current 9-1-1 and E9-1-1 systems have prevented flexible forwarding of emergency call information. Embodiments of the present invention allow flexible rerouting of emergency calls to alternative public safety answering points (PSAPs). Alternate PSAPs may be traditional PSAP equipment or non-traditional PSAP equipment such as a cellular telephone, voice over internet protocol (VoIP) device, or personal digital assistant (PDA). Essentially the reformatter gathers and verifies sending telecommunications device information, identifies a forwarding endpoint, identifies data transmission protocols and formats for the identified forwarding endpoint, and generates and transmits a data message to the forwarding endpoint.

According to certain embodiments, geographic (e.g., XY or XYZ) coordinates are created in order to route 9-1-1 emergency telephone calls based on the caller's location. In these embodiments, geographic coordinates may be included with the data message transmitted to a forwarding endpoint. In other embodiments data messages are generated that mimic the output that would normally be seen by a PSAP operator.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an exemplary system according to one embodiment of the present invention;

FIG. 2 shows an operational flow diagram according to one embodiment of the present invention;

FIG. 3 shows an exemplary block diagram of one embodiment of the call reformatting unit of FIG. 1;

FIG. 4 shows an exemplary format information database from which the call reformatting unit of FIG. 3 may retrieve protocol and format information.

FIG. 5 shows an exemplary message display that may be implemented within a communication device to which call data may be routed from the exemplary call reformatting unit of FIG. 1; and

FIG. 6 shows an exemplary system according to one embodiment of the present invention.

### DETAILED DESCRIPTION

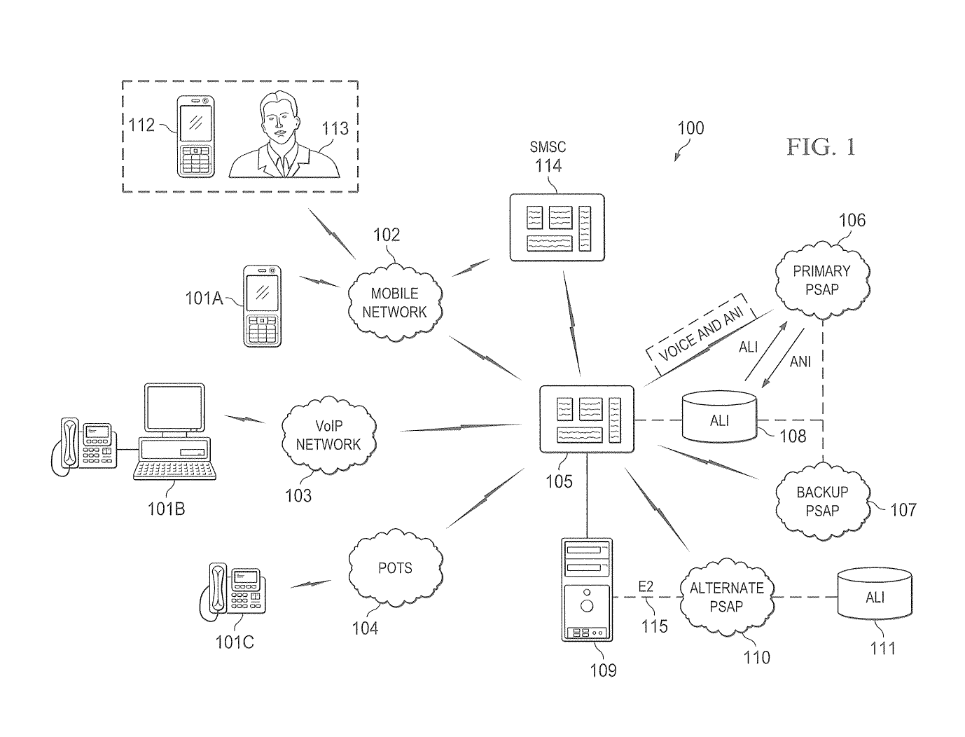

FIG. 1 is block diagram of a system employing one embodiment of the present invention in which a telecommunications device is operable to make an emergency call to a public safety answering point (PSAP). System 100 includes telephony devices 101A-101C mobile network 102 voice over IP (VoIP) network 103, plain old telephone system (POTS) 104, emergency switching center 105, primary public safety access point (PSAP) 106, backup PSAP 107, address lookup information (ALI) database 108, call reformatting unit (CRU) 109, alternate PSAP 1107 ALI database 111, mobile station 112, emergency responder 113, short message service center (SMSC) 114, and E2 interface 115. All or various portions of the devices shown in exemplary system 100 may be present in a given implementation.

Exemplary system 100 comprises a plurality of communication devices that enable communications over a telecommunications network. Each of telephony devices 101A-101C is operable to make voice calls in a telecommunications network. These devices may also enable sending and receiving of data messages (e.g., short message services (SMS) messages, multimedia messaging service (MMS), etc.) For instance, in the example of FIG. 1, mobile station 101A is operable to make voice calls and send and receive SMS messages.

While three exemplary communications devices 101A-101C are shown in FIG. 1, it will be understood that any number of devices may be implemented and three are shown for ease of illustration. Further, while exemplary devices 101A-101C are shown and described in connection with FIG. 1, it will be understood that these types of communication devices are merely illustrative. Any type of communication device that is operable for enabling voice calls or sending a data message to a destination telephone number may be employed within the scope of the present description.

When a user of any one of telephony devices 101A-101C dials 9-1-1 for emergency services, the call is routed to emergency switching center 105 (e.g., a 9-1-1 tandem, a geospatial router as described in co-pending U.S. patent application Ser. No. 11/969,147 entitled “Geographic Referenced Telephone Switching,” of which the present application is a continuation-in-part, etc.). For instance if a 9-1-1 call is made from mobile device 101A, the call is routed according to known methods by mobile network 102 to emergency switching center 105. Likewise when a call for emergency services is placed using VoIP device 101B, the call is routed according to known methods by VoIP network 103 to emergency switching center 105, and when a call for emergency services is placed using telephone 101C, the call is routed through the plain old telephone system (POTS) 104 to emergency switching center 105. Although only networks 102, 103, and 104 are shown and described in connection with FIG. 1 any type of communication network that is operable for routing an emergency communication to an emergency switching center may be employed within the scope of the present description.

Emergency switching center 105 receives incoming emergency calls and directs the call to the appropriate PSAP. Emergency switching center 105 may comprise any number of switching devices, hardware, or software known in the art for selectively routing emergency calls. Emergency switching center 105 routes incoming emergency calls to an appropriate PSAP. In most instances, emergency switching centers route emergency calls to a PSAP based on the location of the entity making an emergency call (e.g., the location of mobile station 101A when a user of the device dials 9-1-1). It will be recognized that any type of emergency switching device that is operable for selectively routing an emergency communication to a PSAP may be employed within the scope of the present description. For purposes of illustration, assume that emergency calls from any of telecommunication devices 101A-101C would typically be routed to primary PSAP 106 based on their geographic location.

When an emergency communication from any of telecommunications devices 101A-101C is received at a PSAP (e.g., primary PSAP 106), the PSAP also receives data that allows the PSAP to identify the entity making the emergency communication. For instance, in the example of FIG. 1, a PSAP receives an automatic number identification (ANI) signal with a voice emergency call. Using the ANI, the PSAP requests and receives the caller's physical address or other location information. In most prior art systems, and as illustrated by FIG. 1, a PSAP (e.g., primary PSAP 106) is in direct communication with an ALI database (e.g., ALI database 108). Although the PSAPs shown in FIG. 1 are coupled to local exchange carrier ALI databases, any type of database or location providing equipment that is operable for routing location information to a PSAP (e.g., a proprietary database provided by a party other than the local exchange carrier, a geospatial router as described in co-pending U.S. patent application Ser. No. 11/969,147 entitled “Geographic Referenced Telephone Switching,” of which the present application is a continuation-in-part, etc.) may be employed within the scope of the present invention.

In the example of FIG. 1, each PSAP is in communication with an ALI database provided by a local exchange carrier. Each PSAP uses received ANI information to query an ALI database, which returns location information related to the calling entity. The information in each ALI database (e.g., ALI database 108) is in a fixed language with a fixed record order and varies based on the database provider (e.g., LEC, third party provider, etc.). There is no universal standardized format for ALI databases; nor is there universal standard PSAP equipment. Thus, each PSAP is configured to communicate with a particular database that provides data in a certain way. In the example of FIG. 1, therefore, the data in ALI database 108 is formatted differently than the data in ALI database 111, and alternate PSAP 110 is configured to communicate and receive data from ALI database 111, but not ALI database 108.

For purposes of illustrating certain shortfalls of the prior art, assume that primary PSAP 106 is abandoned and cannot receive emergency calls. The PSAP might be abandoned, for example, because of a fire at the PSAP, because of a natural disaster such as a hurricane, or the communication means from the emergency switching center might be damaged. Typically, emergency calls to a primary PSAP can be routed to a backup PSAP (e.g., backup PSAP 107) when the primary PSAP is abandoned or disabled. Backup PSAPs typically include similar hardware and access to the same ALI database as the primary PSAP. Thus, in the system illustrated by FIG. 1, when an emergency call is routed to backup PSAP 107, backup PSAP 107 queries ALI database 108 and receives the same information that primary PSAP 106 would have received.

Often, however, the backup PSAP is also abandoned or becomes overloaded. For instance, in the case of large scale disaster like a hurricane, both the primary PSAP 106 and backup PSAP 107 may be abandoned. In such a scenario, it might not be possible in traditional systems to efficiently reroute emergency calls to a backup PSAP that has access to the primary PSAP's ALI database (e.g., ALI database 108 in FIG. 1). In the instance where primary PSAP 106 and backup PSAP 108 are disabled, an emergency call might be rerouted to alternate PSAP 110, but such alternate PSAP 110, in the example of FIG. 1, houses different equipment and utilizes a separate ALI database 111. Consequently, the alternate PSAP may not be able to retrieve location information for an emergency call made from any of telecommunication devices 101A-101C, which would normally be routed to primary PSAP 106 or backup PSAP 107.

Embodiments of the present invention allow routing of emergency calls to alternate PSAPs. As an example, in situations where both a primary PSAP and its backup are disabled or unavailable, embodiments of the present invention allow flexible rerouting of emergency calls to an alternative PSAP. Thus, for instance, calls from emergency devices 101A-101C that would traditionally be routed to PSAP 106 may be rerouted to alternate PSAP 110. As another example, in certain embodiments, emergency service providers might establish a non-traditional, alternative PSAP (e.g., mobile station 112). For instance, when a large geographic area is evacuated due to a disaster, a small group of emergency responders (e.g., emergency responder 113) might stay behind to respond to emergencies that arise after most of the geographic area has been evacuated, wherein emergency calls that would normally be routed to PSAP 106 may be rerouted to mobile station 112, such as a cellular telephone, PDA, etc.

In addition, as discussed further herein, embodiments of the present invention enable not only rerouting of the caller-supplied portions of a call (e.g., voice and/or caller input text message) to an alternate endpoint (e.g., alternate PSAP 110 or mobile station 112), but also enable corresponding call information, such as ANI and/or ALI information, to be rerouted to the alternate endpoint in an appropriate format for output (e.g., display, spoken, etc.) at the alternate endpoint. Accordingly, in certain embodiments the operator receiving the rerouted call at the alternate endpoint also receives the call-related information, such as the corresponding ALI and/or ANI information, in a manner similar to such information being traditionally received and output to an operator at the PSAP 106 (e.g., on an ALI display). Again, such information as the ALI and/or ANI for a call may be reformatted for output in an appropriate format on the alternate endpoint to which the call is rerouted.

In the event that primary PSAP 106 and PSAP 107 are both abandoned, a rule may be implemented in emergency switching center 105 to reroute emergency calls to an alternate endpoint. The alternate endpoint may be another traditional PSAP (e.g., alternate PSAP 110) or it may be a non-traditional PSAP such as mobile station 112, which is capable of receiving data communications (e.g., a short message service (SMS) message, multimedia service (MMS) message, etc.). Switching center 105 may determine, in a traditional manner, a PSAP to which a received 9-1-1 call is to be routed. Upon determining that a rerouting rule has been activated for a determined PSAP, then the rule is processed to determine an alternate endpoint to which the call is to be routed. Thus, in the example of FIG. 1, a rule may be implemented in emergency switching center 105 to reroute emergency calls to that would otherwise be routed to PSAP 106 or PSAP 107 to an alternate endpoint (e.g., alternate PSAP 110 or mobile station 112).

When a call is routed to an alternate endpoint according to embodiments of the present invention, at least a portion of the call-related information may be reformatted by call reformatting unit (CRU) 109. CRU 109 may be implemented, for example, as a stand alone device as shown in the example of FIG. 1. CRU 109 may be implemented as a switch, a router, a PC, etc. In other embodiments, the call reformatting unit may be implemented within an emergency switching device (e.g., emergency switching center 105) or as part of a geospatial router (e.g., a geospatial router, such as described in co-pending U.S. patent application Ser. No. 11/969,147 entitled “Geographic Referenced Telephone Switching,” of which the present application is a continuation-in-part). CRU 109 may also be implemented as software for executing the operations discussed herein. In certain embodiments, CRU 109 reformats emergency call-related information, such as corresponding ALI and/or ANI information, for the call being routed to an alternate endpoint by providing a data message that includes information that would typically be provided to a PSAP operator (e.g., on an ALI display at traditional PSAP 106). For instance, emergency responder 113 might receive a rerouted emergency call on mobile station 112. In addition to routing the emergency voice call, CRU 109 directs a data communication to mobile station 112, which communication may comprise a callback number for the person making the emergency call and location information indicating where the emergency caller is located.

For purposes of illustrating an exemplary embodiment of the present invention, let us assume that PSAP 106 and PSAP 107 have been abandoned. Further assume for this example that mobile station 112 is a cellular telephone enabled to receive voice calls and SMS messages. According to one embodiment, to achieve rerouting of calls from PSAP 106 and/or PSAP 107 to mobile station 112, a rule is implemented in emergency switching center 105 to reroute emergency calls that would normally be routed to PSAP 106 and/or PSAP 107 to mobile station 112. Such a rule may, for example, be implemented as a computer-executable software instruction that is stored to a computer-readable medium, such as to a hard drive, memory (e.g. RAM), or other data storage device. When this rule is implemented (and active), emergency switching center 105 routes calls that would normally be routed to PSAP 106 to CRU 109 for formatting.

According to one embodiment of the present invention, CRU 109 generates a data message that reflects call-related information, such as ALI and/or ANI, that would normally be received at a PSAP. The call-related information may be determined, for example, by querying an ALI database (e.g., ALI database 108 in FIG. 1). In other embodiments the call-related information may be determined by accessing a geospatial router, such as described in co-pending U.S. patent application Ser. No. 11/969,147 entitled “Geographic Referenced Telephone Switching,” of which the present application is a continuation-in-part. Once the call-related information is determined, CRU 109 reformats the information based on the destination endpoint to which the call is to be routed. In the example of FIG. 1, CRU 109 generates an SMS message that includes the callback number and location of an emergency caller. The user supplied portion of the emergency communication (e.g., voice, text, etc.) is then routed to mobile station 112 and the generated SMS message is pushed to the mobile station 112 by known methods over mobile network 102. For instance, as shown in FIG. 1, the SMS message containing the ANI and ALI is communicated to SMSC 114. The SMSC 114 provides a connection between CRU 109 and mobile station 112 by way of mobile network 102. Thus embodiments of the present invention allow rerouting of a user supplied portion of an emergency communication (e.g., voice, text, etc.) to an alternate or nontraditional PSAP and call-related info (e.g., ALI/ANI) to be routed to the alternate or nontraditional PSAP for output by the alternate/nontraditional PSAP (e.g., as a voice message, display to a mobile station's display screen, etc.) While SMS is described for communicating the call-related information in this example other data communication techniques may be employed, such as MMS, communicating a text file, or communicating an image file containing the call-related information.

FIG. 5 illustrates the data portion 500 of an emergency call routed to an alternate, non-traditional PSAP such as mobile station 112 in the example of FIG. 1. Message portion 501 indicates that the incoming message is an emergency call. Message portion 502 displays the emergency caller s ANI (callback number), and message portion 503 displays the emergency caller's ALI (location information). Accordingly, the call-related information, such as ANI and ALI for the call routed to mobile station 112 may be presented on the display of such mobile station. Thus, emergency responder 113 may receive and respond to emergency calls using mobile station 112 when traditional PSAPs (e.g., primary PSAP 106 and backup PSAP 107 in the example of FIG. 1) are unavailable.

Alternatively, according to other embodiments of the present invention, a rule may be established to route an emergency call to an alternate traditional PSAP (e.g., alternate PSAP 110 shown in FIG. 1). Currently there are approximately 37 different ALI formats in use in the United States for PSAP equipment. According to embodiments of the present invention, CRU 109 is implemented to be aware of and reformat data to match the output for each of the ALI formats in use in the United States for PSAP equipment. Thus, in the example of FIG. 1, when a rule is implemented to route an emergency call to alternate PSAP 110, CRU 109 determines location and call back information and generates a data communication including that information in a format that can be used by alternate PSAP 110. The data communication, as illustrated in FIG. 1, is communicated to PSAP 110 via E2 network 115 while the voice call may be connected via a voice connection. Of course other data communications may be employed in other embodiments.

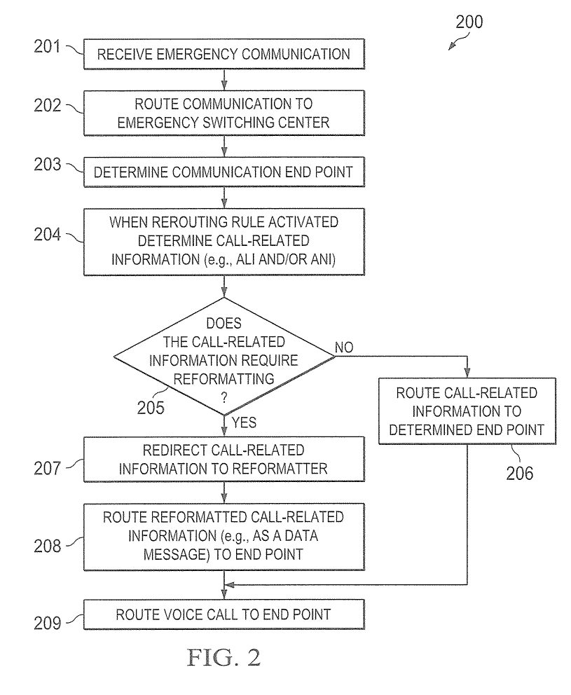

Turning now to FIG. 2, an exemplary operational flow diagram 200 of emergency call rerouting according to one embodiment of the present invention is illustrated. In process block 201, an emergency communication by a communication network is received. For instance, in the example of FIG. 1, mobile network 102 may receive an emergency 9-1-1 call from telecommunications device 101A. In process block 202, the communication is identified as an emergency call (e.g., based on the 9-1-1-number to which it was directed) and is thus routed to an emergency switching center. For instance, in the example of FIG. 1, mobile network 102 routes the 9-1-1 call to emergency switching center 105.

In process block 203, a communication end point is determined. In the example of FIG. 1, emergency switching center 105 determines to what entity an incoming emergency call should be routed (e.g., PSAP primary 106, backup PSAP 107, alternate PSAP 110, mobile station 112, etc.). In one embodiment, such determining is based on whether a rule has been enabled that forwards an emergency call to an alternate traditional or non-traditional PSAP. For instance, in the example of FIG. 1, a call from emergency caller 102 would normally be routed to primary PSAP 106. In the event that a rerouting rule is active for the primary PSAP 106 (e.g., if primary PSAP 106 and backup PSAP 107 are unavailable), emergency calls that would normally be routed to primary PSAP 106 or backup PSAP 107 can instead be routed to an alternate endpoint as designated by the rerouting rule, such as to alternate PSAP 110 or to a non-traditional PSAP such as mobile station 112.

In process block 204, call related information is determined. In the example of FIG. 1, when a rerouting rule is enabled and active in switching center 105, CRU 109 determines call-related information for the emergency communication that is being rerouted. The call-related information may be determined, for example, by querying an ALI database (e.g., ALI database 108 in FIG. 1). In other embodiments the call-related information may be determined by accessing a geospatial router, such as described in co-pending U.S. patent application Ser. No. 11/969,147 entitled “Geographic Referenced Telephone Switching,” of which the present application is a continuation-in-part.

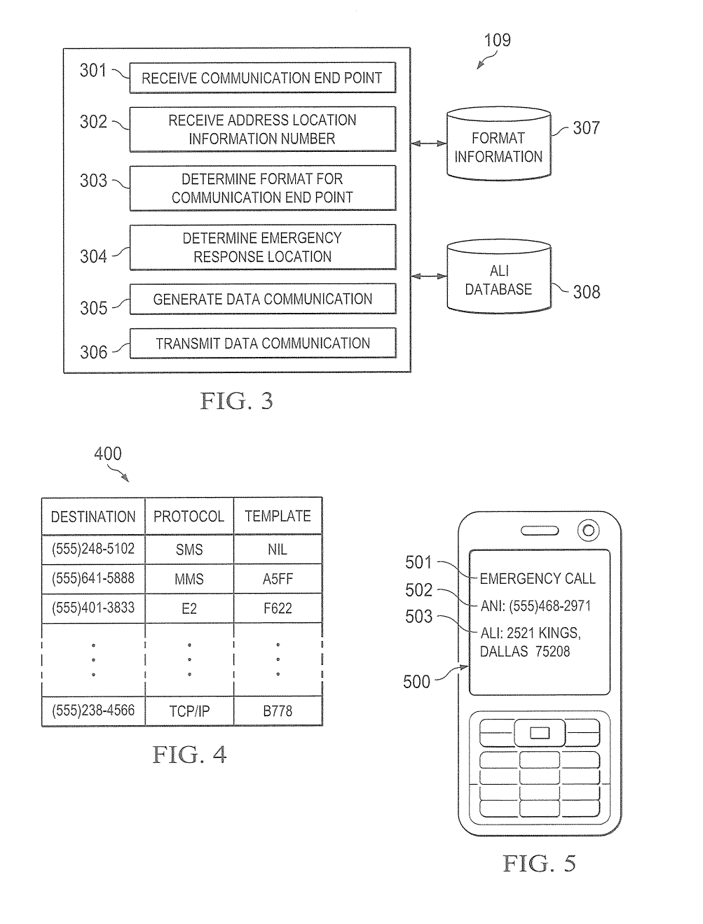

In process block 205, a determination is made as to whether the call-related information needs reformatting. In the example of FIG. 1, an emergency call rerouted to a non-traditional PSAP, such as mobile station 112, or alternate PSAP 110, which does not have access to ALI database 108 and may use different hardware than PSAPs 106 and 107, requires reformatting. If the call-related information does not require reformatting, the call is routed to the designated end point at process 206. If the call-related information does require reformatting, the communication is directed to a call reformatter (e.g., CRU 109 shown in FIG. 1) at process 207. Reformatting may involve generating a data message in a communication protocol and format that can be received and displayed on an output of an alternate traditional or non-traditional PSAP. Exemplary reformatting that may be employed will be described in greater detail below in connection with FIG. 3.

In process block 208 the reformatted call-elated information is routed (e.g., as a data communication) to the determined end point. This data communication can be any transmitted by any suitable protocol known in the art (e.g., SMS, MMS, TCP/IP, E2 interface, etc.). Any type of communication protocol that is operable for enabling text based data communications may be employed within the scope of the present description. Similarly, in certain embodiments the text information may be converted to voice and transmitted as a .wav or other audio file. In the example of FIG. 1, non-traditional PSAP mobile station 112 is enabled to receive SMS messages and alternate traditional PSAP 110 is enabled to receive messages over E2 network 115. In process block 209, the voice call is routed to the determined endpoint. In certain embodiments, separate voice and data portions are routed to the determined endpoint. In other embodiments, the voice and data portions of a reformatted emergency communication may be transmitted together (e.g., over a common network interface). Referring to FIG. 1, for example, if an emergency call is routed to mobile station 112, CRU 109 may route a data communication (e.g., SMS message, MMS message, etc) to mobile station 112 and a corresponding voice call to mobile station 112. The data communication would include, for example, a call back number and emergency response location for the emergency caller.

Turning now to FIG. 3, an exemplary block diagram of one embodiment of a call reformatting unit (e.g., CRU 109) is shown. In this example, CRU 109 includes an interface 301 for receiving (e.g., from emergency switching center 105 in the example of FIG. 1) a communication end point for an emergency call being rerouted to an alternative PSAP (e.g., mobile station 112). The communication end point in one embodiment comprises the telephone number associated with an emergency responder (e.g., the telephone number associated with mobile station 112 operated by emergency responder 113 in the example of FIG. 1).

CRU 109 further includes an interface 302 for receiving an ANI. The ANI may be used, for example, by an emergency responder or by an operator at the alternative PSAP to callback an emergency caller (e.g., an emergency caller operating device 101A). In the embodiment illustrated by FIG. 1, the ANI is provided to CRU 109 by emergency switching center 105.

CRU 109 further includes logic 303 (e.g., software stored to a computer-readable medium and being executed by a processor of the CRU 109) to determine the proper format for the received communication end point to which the call information is to be routed. There are many different ALI formats in use in the United States for PSAP equipment. According to one embodiment, logic unit 303 is implemented to be aware of and reformat its data to match the output for every one of those different formats. Additionally, logic 303 is implemented to determine the protocol by which a data communication to an alternate PSAP should be communicated. The reformatting may include reorganizing the data (e.g., into a different order and/or different field lengths) and/or changing the data protocol or file format, such as to image file, SMS, etc. Reformatting may also include inserting certain data, such as field headers/labels to correspond to a PSAP display.

For instance, CRU 109 is communicatively coupled to format database 307 that is stored to a computer-readable medium (e.g., hard drive, memory, optical disk, magnetic disk, or other data storage device for storing computer-readable data), wherein database 307 includes format information for various different endpoints, such as what data protocol an alternate or non-traditional PSAP is enabled to receive, what information should be provided to the PSAP (e.g., callback number, address information, geographic coordinates, etc.), and how the information should be provided to the alternate PSAP (e.g., in what order data should be presented or if there is a template for preparing the data communication). An exemplary implementation of format database 307 will be described in more detail in relation to FIG. 4 below. Thus, logic 303 of CRU 109 may determine what information to send to a communication endpoint and in what format the data should be sent by querying format database 307.

CRU 109 further includes logic 304 (e.g., software stored to a computer-readable medium and being executed by a processor of the call reformatting unit 109) to determine an emergency response location (ALI) for the entity making the emergency. For instance, in the example of FIG. 3, CRU 109 is communicatively coupled to ALI database 308 that is stored to a computer-readable medium (e.g., hard drive, memory, optical disk, magnetic disk, or other data storage device for storing computer-readable data), wherein database 308 includes location information related to emergency callers. Thus, logic 304 of CRU 109 determines the location of an emergency caller by querying database 308. In the example of FIG. 1, CRU 109 queries ALI database 108 to determine location information. In other embodiments, CRU 109 might query proprietary databases such as VIXXI Solution Inc's geocoded, static ALI database or request location information from an emergency switching center or a geospatial router.

CRU 109 further includes logic 305 for generating a data communication. Logic 305 is adapted to generate a data message that can be read on an alternative endpoint (e.g., alternate traditional PSAP 110 or non-traditional PSAP 112 in the example of FIG. 1). Based on the format determined by logic 303, logic 305 generates a message readable at the alternate endpoint to which the call is being rerouted.

For instance, with reference to FIGS. 1 and 3, mobile station 112 is adapted to receive short message service (SMS) messages. Message generator 305 is adapted to generate an SMS message that includes the ANI and ALI for an emergency caller making an emergency call from device 101A. Alternatively, if mobile station 112 were adapted to receive an MMS message, message generator 305 could generate an image file with emergency caller 101's call back information (e.g., ANI) and emergency response location (e.g., ALI). In certain embodiments, the message is constructed based on a template. In these embodiments, format database 307 would indicate that message format is provided by a template and reference where the template is stored (see, e.g., the template column of records 400 illustrated by FIG. 4). This template would, for example, allow the generating logic to create a message that mimics what a PSAP operator would normally see on his or her station. In certain embodiments this is done, for example, by adapting message generator 305 to generate an image (e.g., JPEG, GIF, etc.) that includes call back and location information and mimics what is output on a PSAP operator's work station. In this way, the CRU is operable to generate an emergency message that mimics what is normally seen by a PSAP operator. In other words, database 307 may relate a given endpoint to a corresponding template that defines a desired output format, where the template may be populated with the call-related information to form the data communication to send the alternate endpoint.

Still referring to FIG. 3, message generator 305 is also adapted to generate a message for traditional PSAP equipment (e.g., alternate PSAP 110). For instance, in the example of FIG. 1, message generator 305 is operable to generate a data communication to be communicated to alternate PSAP 110. This message, in the example of FIG. 1, is generated in a protocol suitable for communication over the E2 network 115.

CRU 109 further includes an interface 306 for transmitting data messages to a communications network. For instance, in the example of FIG. 1, interface 306 transmits an SMS message to mobile station 112. Interface 306 is also operable to transmit other forms of data communication such as MMS messages, TCP/IP messages, and messages over the E2 network.

FIG. 4 illustrates exemplary records 400 stored in format database 307 (shown in FIG. 3). Each database record stored in format database 307 contains fields for a destination, such as numbers for an emergency end point, a protocol field, and a template field. In the exemplary database of FIG. 4, each destination is associated with a particular end point, such as mobile station 112 (shown in FIG. 1). The protocol field signifies what communication protocol data communications to a particular destination should be provided in. The template field indicates whether and where a template for generating a data message is stored for a particular destination. In other embodiments, records may include a format field identifying how messages should be formatted (e.g., what information should be provided, in what order information should be provided, etc.).

Embodiments of the present invention are not limited in applicability to situations were rerouting is required due to disability or abandonment of PSAPs. Situations may arise, for example, where flexible rerouting is desired to address emergencies that require establishing a mobile or temporary command center. For example, where an incident such as a hazardous material release occurs, a mobile command center can be established to handle all emergency calls originating from the contamination area. As another example, an emergency situation (e.g., a shooting) on a university campus may give rise to a desire to deploy a mobile command post on the university campus.

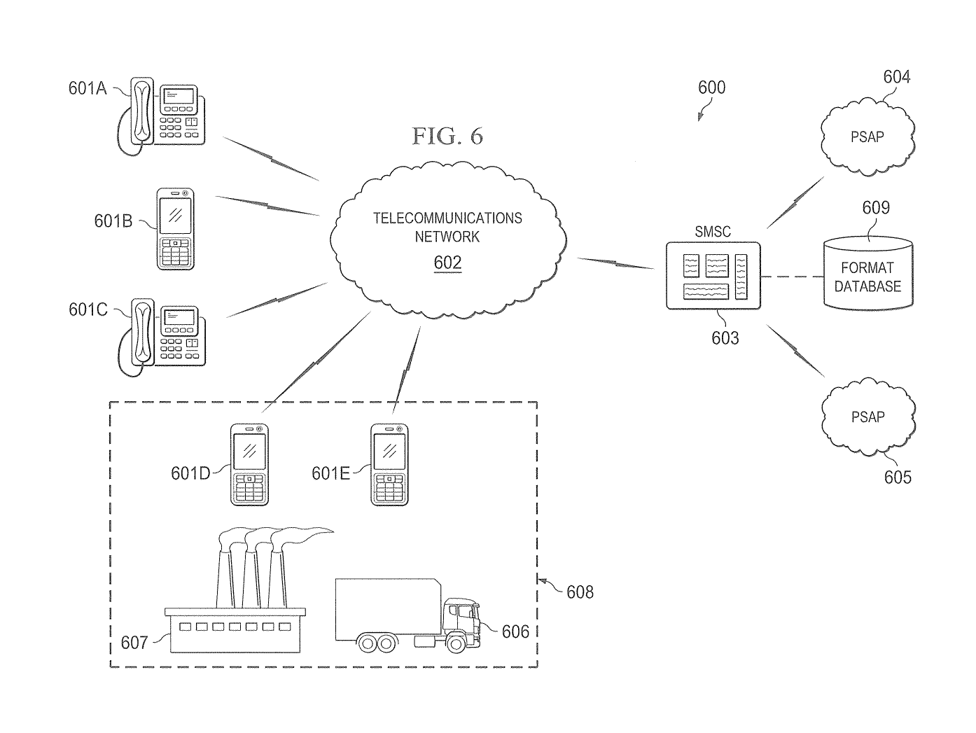

FIG. 6 illustrates a scenario in which an embodiment of the present invention is used to create a mobile command post. System 600 includes communication devices 601A-601E, telecommunications network 602, geospatial router 603 (e.g., a geospatial router as described in co-pending U.S. patent application Ser. No. 11/969,147 entitled “Geographic Referenced Telephone Switching,” of which the present application is a continuation-in-part), PSAP 604, PSAP 605, mobile command center 606, chemical plant 607, contamination zone 608, and format database 609. For purposes of illustration, assume that a chemical release event occurred at chemical plant 607 and contamination zone 608 is affected by the chemical release. For purposes of illustration, also assume that mobile command station 606 is set up in the contamination zone 608 to respond to the release and a larger than normal number of emergency calls in the contamination zone. Note that contamination zone 608 may be a subset of the area for which PSAP 604 services.

In the example of FIG. 6, an emergency call (e.g., a 9-1-1 call) or text from any of communications devices 601A-601E is routed through telecommunications network 602 to geospatial router 603. Geospatial router 603 determines the proper endpoint to which an emergency communication should be sent for servicing. The endpoint is determined, at least in part, on the determined current geographical location of the sending devices (e.g., the location of devices 601A-601E). In the embodiment illustrated by FIG. 6, this determination is performed as a database lookup (e.g., as discussed above with database 108 of FIG. 1) using the determined geographical location of the sending device for determining from the database a corresponding endpoint for servicing the emergency call. It will be recognized, however, that any type of geospatial routing that is operable for selectively routing an emergency call based on a caller's geographic location is adaptable to embodiments of the present invention.

Exemplary techniques for performing geospatial routing, which may be adapted for use are described in co-pending and commonly-assigned U.S. patent application Ser. No. 11/967,147 titled “GEOGRAPHIC REFERENCED TELEPHONE SWITCHING,” filed Jan. 3, 2008, which claims priority to U.S. Provisional Patent Application Ser. No. 60/980,697 titled “GEOGRAPHIC REFERENCED TELEPHONE SWITCHING,” filed Oct. 17, 2007, the disclosures of which are incorporated herein by reference. According to the exemplary embodiment of FIG. 6, geospatial router 603 may include software and hardware for performing flexible forwarding of the data portion of an emergency call. The geospatial router determines the location of the caller by generating an XY coordinate, and does an ALI look-up for that caller. A rule can be established within a geospatial router to identify those calls originating within the contamination area 608, which are to be routed to the command post 606. In the present example, a rule has been implemented in geospatial router 603 to forward emergency communications originating from contamination zone 608 (e.g., emergency calls from telecommunications devices 601D and 601E) to mobile command station 606.

In the example of FIG. 6, the geospatial router determines the correct communication end point, and selects the correct voice termination (e.g., a 10 digit telephone number, a set of CAMA trunks, a different PSAP, etc). After the communication end point is determined, geospatial router 603 generates a data message for mobile command station 606. The data message may be generated in a manner as discussed above with FIG. 3. In the embodiment illustrated by FIG. 6, software is implemented within geospatial router 603 to reformat call related information for incoming calls to include a data portion for telecommunication devices at command center 606. In the example of FIG. 6, geospatial router 603 queries format database 609 to determine in what data protocol and format mobile command center 606 is operable to receive data. Software within the router then generates a data message containing caller information (e.g., ANI, ALI, geographic coordinates, etc.) in a protocol and format appropriate for a particular receiver (e.g., command center 606). Geospatial router 603 then routes the voice call and data message to the appropriate end point—command center 606 in the example of FIG. 6.

Many of the elements described herein, when implemented via computer-executable instructions, are in essence the software code defining the operations thereof. For instance, the above-described call reformatting unit 109 may comprise software code for performing the operations described as being performed by the call reformatting unit 109. The executable instructions or software code may be obtained, for example, from a readable medium (e.g., a hard drive media, optical media, EPROM, EEPROM, tape media, cartridge media, flash memory, ROM, memory stick. and/or the like). In certain embodiments, a CPU may execute the various logical instructions according to embodiments of the present invention. For example, a CPU may execute machine-level instructions according to the exemplary operational flow described above in conjunction with FIG. 2.

It shall be appreciated that the present invention is not limited to the architecture of the system on embodiments thereof may be implemented. For example, any suitable processor-based device may be utilized for implementing the above-described call reformatting unit, including without limitation personal computers, laptop computers, computer workstations, and multi-processor servers. Moreover, certain aspects of embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

While emergency (e.g., 9-1-1 or E9-1-1 type calls) are described in many of the exemplary embodiments provided herein, it should be recognized that the concepts described herein may be likewise employed for other special calling systems. For example, there are other abbreviated number calling systems in place in the United States and abroad for such purposes as handling municipal information and services calls (e.g., 3-1-1 calls) and for other special purposes. All of these special, or abbreviated number call systems that have geographic-based content may be implemented for supporting text messaging to an action-response facility geographically proximate to the locus of the caller in a manner similar to that described herein for emergency calls.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for routing a geographically-sensitive communication comprising:
receiving call-related information for a geographically-sensitive communication from a telecommunications device;
determining a proper service point to which the geographically-sensitive communication is to be routed;
determining an output format for a call-related information output of the proper service point; and
generating a message in the determined output format.

2. The method of claim 1 wherein the determining a proper service point comprises identifying a present physical location of the telecommunications device.

3. The method of claim 2 wherein the identifying a present physical location comprises accessing an automatic location information database.

4. The method of claim 2 wherein the identifying a present physical location of the telecommunications device comprises accessing a geospatial router.

5. The method of claim 3 wherein determining a proper service point is based at least in part on whether a forwarding rule directing calls from a first service point to a second service point has been enabled.

6. The method of claim 5 wherein the first service point is a public safety answering point (PSAP).

7. She method of claim 6 wherein the second service point is a non-traditional PSAP enabled to receive data messages.

8. The method of claim 5 wherein the determining an output format comprises determining, an output protocol.

9. The method of claim 8 wherein the determining an Output protocol comprises accessing a format database.

10. The method of claim 9 further comprising sending the message to the identified proper service point for output on the call-related information output and routing a voice portion of the geographically-sensitive communication.

11. A method for routing a geographically-sensitive communication comprising:
receiving an emergency communication at an emergency switching center;
determining a communication endpoint for the emergency communication;
routing the emergency communication to a call reformatting unit when a rerouting rule is activated;
generating a call-related information message;
routing the call-related information message to the communication endpoint; and
routing the emergency communication to the communication endpoint.

12. A call reformatting unit comprising:
an interface for receiving a service point to which a communication from a telecommunications device should be routed;
an interface for receiving location information for the telecommunications device;
determining logic for determining a data communication format for the service point;
generating logic for generating a data communication in the data communication format for the service point; and
a communication interface for sending the generated data communication to a service point.

13. The call reformatting unit of 12 further comprising logic for determining an emergency response location.

14. The call reformatting unit of 12 wherein the received location information is a set of geographic coordinates.

15. The call reformatting unit of 12 wherein the determining logic for determining data communication protocol further comprises logic for determining a data communication format.

16. The call reformatting unit of 12 wherein the determining logic and generating logic is configured on an application-specific integrated circuit (ASIC).

17. The call reformatting unit of 12 wherein the determining logic and generating logic is configured on a gate array.

18. A telephone switching device comprising a computer readable medium having computer readable program code embodied therein, wherein execution of said computer readable program code by a processor of said switching device causes the device to perform a method comprising:
receiving from telephone switching equipment a service point for an emergency communication from a telecommunications device;
receiving from telephone switching equipment location information for the telecommunications device;
determining by the telephone switching device an emergency response location;
identifying by the telephone switching device a data message protocol for the service point;
identifying by the telephone switching device a data message format for the service point; and
generating a data message in the data message protocol with the data message format;
transmitting the data message to the communication end point.

19. The telephone switching device of 18 wherein the location information for the telecommunications device is an automatic location identification number.

20. The telephone switching device of 18 wherein the location information for the telecommunications device is geographic coordinates.

21. The telephone switching device of 18 wherein the determining by the telephone switching device an emergency response location comprises querying an automatic location identification database.

22. The telephone switching device of 18 wherein the determining by the telephone switching device an emergency response location comprises querying an geospatial router.

23. The telephone switching device of 22 wherein the identifying by the telephone switching device a data message protocol for the communication end point comprises querying a protocol database.

24. The telephone switching device of 23 wherein the generating a data message in the data message protocol with the data message format comprises using a template.

25. The telephone switching device of 18 wherein the identifying by the telephone switching device a data message format for the communication end point comprises querying a format database.
